(19) United States
(12) Patent Application Publication
(10) Pub. No.: US 2016/0077386 A1
(43) Pub. Date: Mar. 17, 2016

(54) DISPLAY PANEL

(71) Applicant: INNOLUX CORPORATION, Jhu-Nan (TW)

(72) Inventors: Tsung-Han TSAI, Jhu-Nan (TW); Chao-Hsiang WANG, Jhu-Nan (TW); An-Chang WANG, Jhu-Nan (TW)

(21) Appl. No.: 14/548,171

(22) Filed: Nov. 19, 2014

(30) Foreign Application Priority Data
Sep. 17, 2014 (TW) 103132097

(51) Int. Cl. G02F 1/1343

(52) U.S. Cl. CPC G02F 1/134309

(57) ABSTRACT

A display panel includes a first substrate, a second substrate and an electrode layer. The electrode layer is disposed on the first substrate and faces the second substrate, and includes a plurality of electrode portions. The electrode portions are disposed along a direction and separated from each other by a first distance (S). When a light passes through the electrode portions, a brightness distribution composed of a plurality of bright textures and a plurality of dark textures is generated. The dark textures include a first dark texture, a second dark texture and a third dark texture which consecutively occur. The centers of the first dark texture and third dark texture are separated by a second distance (K). K and S satisfy the following equation:

(−0.43715×S²+4.37035×S²−13.49956×S+17.98982)−0.5≦K≦(−0.43715×S³+4.37035×S²−13.49956×S+17.98982)+0.5, 1≦S≦10,

and S and K in unit of micrometer.

### CROSS REFERENCE TO RELATED APPLICATIONS

This Non-provisional application claims priority under 35 U.S.C. §119(a) on Patent Application No(s). 103132097 filed in Taiwan, Republic of China on Sep. 17, 2014, the entire contents of which are hereby incorporated by reference.

### BACKGROUND OF THE INVENTION

1. Field of Invention

The invention relates to a display panel and, in particular, to a display panel having a higher transmittance.

2. Related Art

With the progress of technologies, flat display devices have been widely applied to various kinds of fields. Especially, liquid crystal display (LCD) devices, having advantages such as compact structure, low power consumption, less weight and less radiation, gradually take the place of cathode ray tube (CRT) display devices, and are widely applied to various electronic products, such as mobile phones, portable multimedia devices, notebooks, LCD TVs and LCD screens.

A conventional LCD apparatus mainly includes an LCD panel and a backlight module disposed opposite to the LCD panel. The LCD panel mainly includes a thin film transistor (TFT) substrate, a color filter (CF) substrate and a liquid crystal layer disposed between the two substrates. The CF substrate, the TFT substrate and the LC layer can form a plurality of pixel units disposed in an array. The backlight module can emit the light passing through the LCD panel, and the pixel units of the LCD panel can display colors forming images accordingly.

For the same illuminance, a display panel with a higher transmittance can save more power for the display device. Therefore, the industry strives to increase the transmittance of the display panel to save more energy and enhance the product competitiveness. The pattern design of the transparent conductive layer of the TFT substrate is a key factor in the transmittance of the display panel. Especially with the increasingly high resolution of the panel, the pattern of the transparent conductive layer is a factor that needs to be considered to configure the panel with a higher transmittance.

### SUMMARY OF THE INVENTION

An objective of the invention is to provide a display panel having a higher transmittance to increase the product competitiveness.

To achieve the above objective, a display panel according to the invention includes a first substrate, a second substrate disposed opposite the first substrate, and an electrode layer. The electrode layer is disposed on the first substrate and faces the second substrate, and includes a plurality of electrode portions. The electrode portions are disposed along a direction and separated from each other by a first distance (S). When a light passes through the electrode portions, a brightness distribution composed of a plurality of bright textures and a plurality of dark textures is generated. The dark textures include a first dark texture, a second dark texture and a third dark texture which consecutively occur. The centers of the first dark texture and third dark texture are separated by a second distance (K). K and S satisfy the following equation:

(−0.43715×S³+4.37035×S²−13.49956×S+17.98982)−0.5≦K≦(−0.43715×S³+4.37035×S²−13.49956×S+17.98982)+0.5, 1≦S≦10,

and S and K in unit of micrometer.

To achieve the above objective, a display panel according to the invention includes a first substrate, a second substrate disposed opposite the first substrate, and an electrode layer. The electrode layer is disposed on the first substrate and faces the second substrate, and includes a plurality of electrode portions. The electrode portions are disposed along a direction and separated from each other by a first distance (S). When a light passes through the electrode portions, a brightness distribution is generated and has a brightness distribution curve along the direction, and the brightness distribution curve is composed of a plurality of wave peaks and a plurality of wave valleys. The wave valleys include a first wave valley, a second wave valley and a third wave valley occurring consecutively, and the first wave valley and the third wave valley are separated by a second distance (K). K and S satisfy the following equation:

(−0.43715×S³+4.37035×S²−13.49956−S+17.98982)−0.5≦K≦(−0.43715×S³+4.37035×S²−13.49956×S+17.98982)+0.5, 1≦S≦10,

and S and K in unit of micrometer.

As mentioned above, in the display panel of the invention, the electrode portions of the electrode layer are disposed along a direction and separated from each other by a first distance (S). When a light passes through the electrode portions, a brightness distribution composed of a plurality of bright textures and a plurality of dark textures is generated. The dark textures include a first dark texture, a second dark texture and a third dark texture occurring consecutively, and the centers of the first dark texture and third dark texture are separated by a second distance (K). Or, when a light passes through the electrode portions, a brightness distribution is generated and has a brightness distribution curve along the direction, and the brightness distribution curve is composed of a plurality of wave peaks and a plurality of wave valleys. The wave valleys include a first wave valley, a second wave valley and a third wave valley occurring consecutively, and the first wave valley and the third wave valley are separated by a second distance (K). The display panel can have a better transmittance when K and S satisfy the following equation:

(−0.43715×S³+4.37035×S²−13.49956×S+17.98982)−0.5≦K≦(−0.43715×S³+4.37035×S²−13.49956×S+17.98982)+0.5, 1≦S≦10,

and S and K in unit of micrometer.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram showing a pixel of a display panel of an embodiment of the invention;

FIG. 1B is a schematic diagram showing the cross-section taken along the line A-A in FIG. 1A and the corresponding brightness distribution curve along a direction;

FIG. 1C is a schematic diagram of the image of a pixel of the display panel in FIG. 1A;

FIG. 1D is a schematic diagram of the second electrode layer in FIG. 1B;

FIG. 2A is a schematic diagram showing the bright texture period and the brightness distribution integral function under the optimum transmittance;

FIG. 2B is a schematic diagram showing the optimum value of the bright texture period and the first distance under the optimum transmittance;

FIG. 3A is a schematic sectional diagram of a display panel of another embodiment of the invention;

FIG. 3B is a schematic diagram of the second electrode layer of the display panel in FIG. 3A;

FIGS. 3C to 3F are schematic diagrams of the pixels of the display panels, respectively, of other embodiments of the invention;

FIG. 4 is a schematic diagram of a display device of an embodiment of the invention; and

FIG. 5 is a schematic diagram of the smoothed brightness distribution curve that is obtained by smoothing the original brightness distribution curve.

### DETAILED DESCRIPTION OF THE INVENTION

The present invention will be apparent from the following detailed description, which proceeds with reference to the accompanying drawings, wherein the same references relate to the same elements.

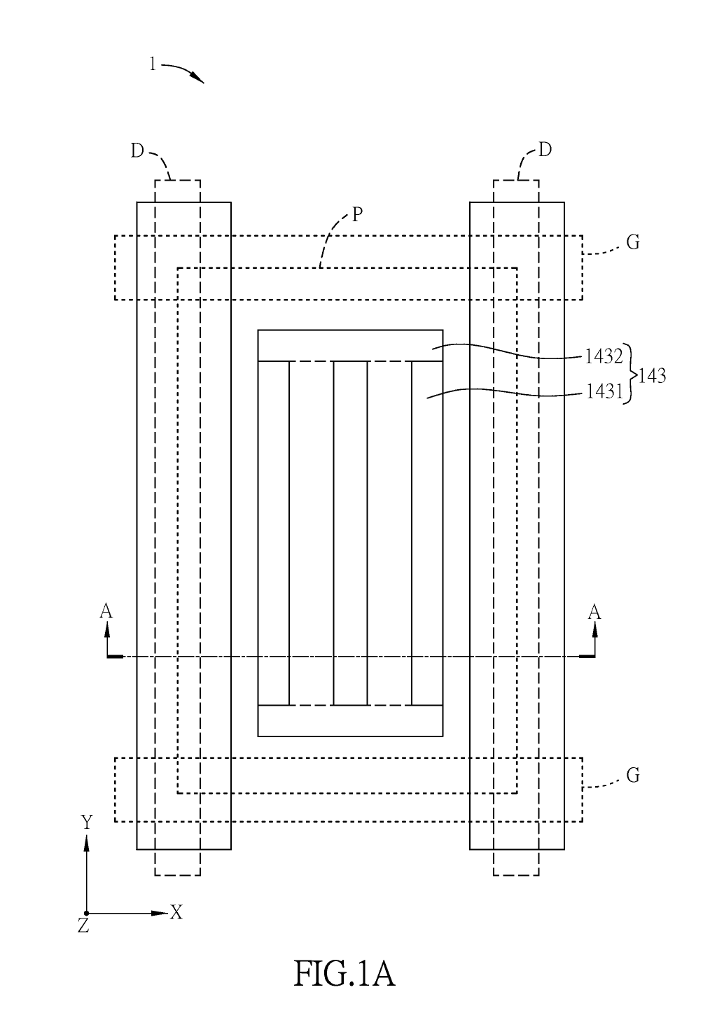

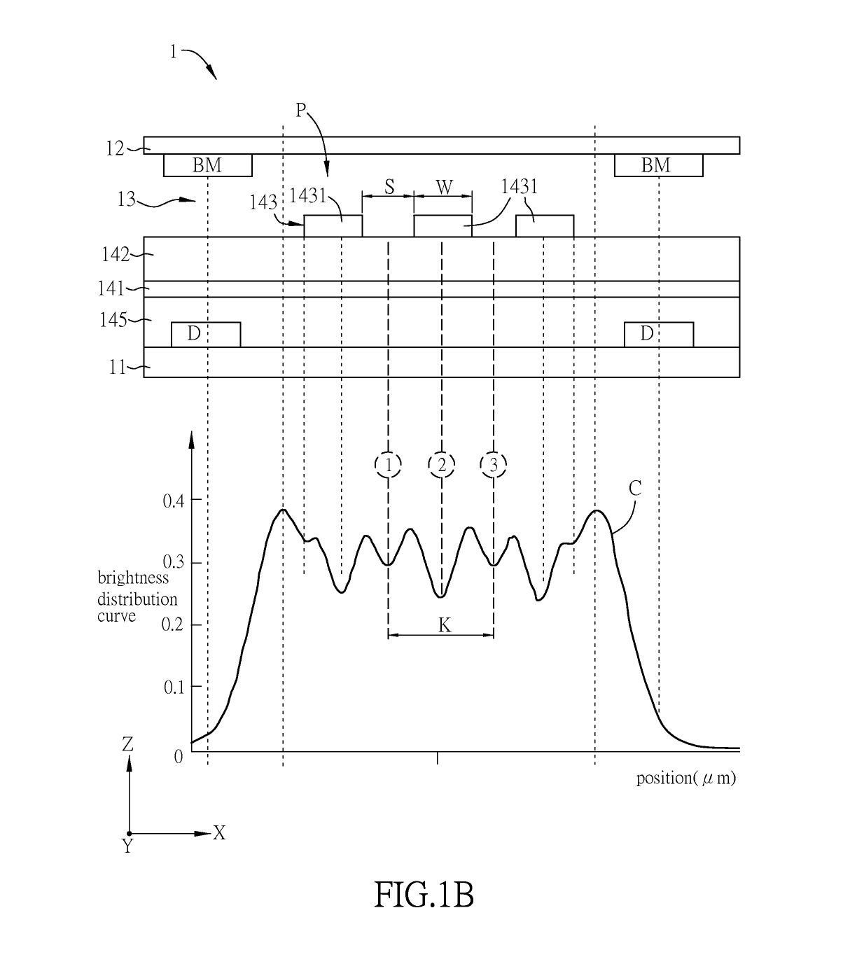

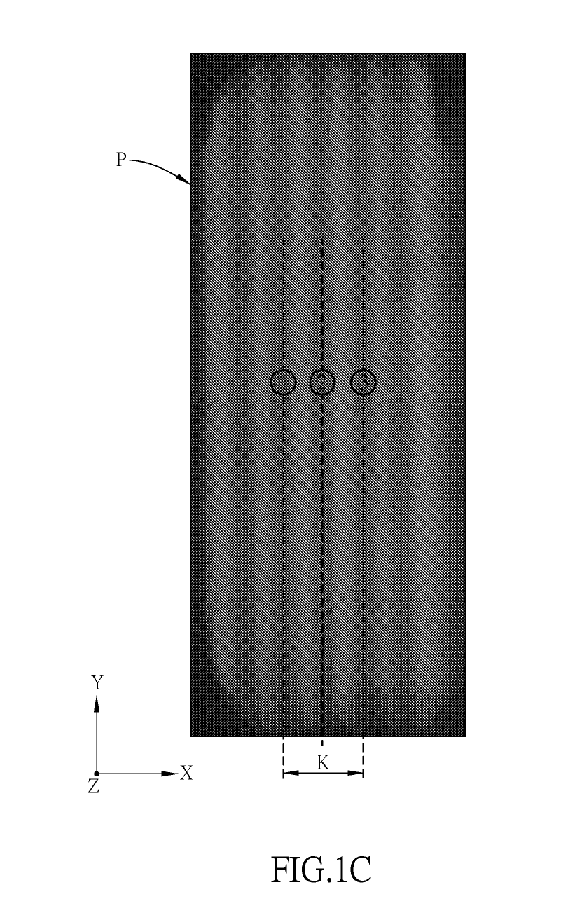

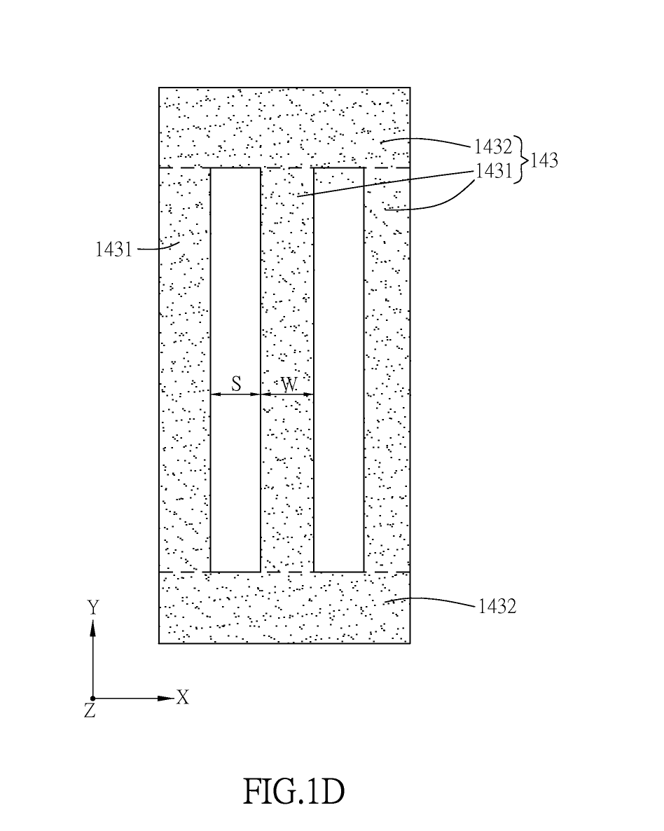

FIG. 1A is a schematic diagram showing a pixel P of a display panel 1 of an embodiment of the invention, FIG. 1B is a schematic diagram showing the cross-section taken along the line A-A in FIG. 1A and the corresponding brightness distribution curve along a direction X, FIG. 1C is a schematic diagram of the image of a pixel P of the display panel in FIG. 1A, and FIG. 1D is a schematic diagram of the second electrode layer 143 in FIG. 1B.

The display panel 1 of this embodiment is, for example but not limited to, a fringe field switching (FFS) LCD panel or other kinds of horizontal driving LCD panels. Besides, for the easy understanding, FIG. 1A just shows the disposition of two scan lines G, two data lines D, one pixel P and a second electrode layer 143 of the display panel 1 without showing other elements of the display panel 1. Moreover, in this embodiment, a first direction X (horizontal direction), a second direction Y (perpendicular direction) and a third direction Z are shown in FIGS. 1A to D, and any two of them are perpendicular to each other. The first direction X is substantially parallel to the extension direction of the scan line G, the second direction Y is substantially parallel to the extension direction of the data line D, and the third direction Z is perpendicular to the first and second directions X and Y.

As shown in FIG. 1B, the display panel 1 includes a first substrate 11, a second substrate 12 and a liquid crystal layer 13. The first and second substrates 11 and 12 are disposed oppositely and the liquid crystal layer 13 is disposed between the first and second substrates 11 and 12. The first and second substrates 11 and 12 are made by transparent material, and each of them is, for example but not limited to, a glass substrate, a quartz substrate or a plastic substrate. The display panel 1 further includes a pixel array disposed on the first substrate 11. The pixel array includes at least a pixel (or called a sub-pixel) P, and here are a plurality of pixels P for example. The pixels P are disposed between the first substrate 11 and the second substrate 12 and arranged in a matrix. Moreover, the display panel 1 of this embodiment can further include a plurality of scan lines and a plurality of data lines D. The scan lines G and the data lines D cross each other and are perpendicular to each other to define the area of the pixel array.

The pixel P includes a first electrode layer 141, an insulating layer 142 and a second electrode layer 143. In this embodiment, the first electrode layer 141, the insulating layer 142 and the second electrode layer 143 are sequentially disposed, from bottom to top, on the side of the first substrate 11 facing the second substrate 12. The data line D is disposed on the first substrate 11. The pixel P can further include another insulating layer 145 covering the data line D, and the first electrode layer 141 is disposed on the insulating layer 145. The insulating layer 142 covers the first electrode layer 141 and the second electrode layer 143 is disposed on the insulating layer 142. Therefore, the first electrode layer 141 can be disposed between the insulating layers 142 and 145, and the first electrode layer 141, the data line D and the second electrode layer 143 won't be short-circuited therebetween. The material of the insulating layers 142, 145 can include SiOx, SiNx or other insulating materials for example, but this invention is not limited thereto. Moreover, each of the first and second electrode layers 141 and 143 is a transparent conductive layer, and the material thereof is, for example but not limited to, indium-tin oxide (ITO) or indium-zinc oxide (IZO). In this embodiment, the second electrode layer 143 is a pixel electrode and electrically connected (not shown) with the data line D, and the first electrode layer 141 is a common electrode. However, in other embodiments, the second electrode layer 143 can be a common electrode while the first electrode layer 141 is a pixel electrode.

The display panel 1 can further include a black matrix BM and a color filter layer (not shown). The black matrix BM is disposed on the first substrate 11 or the second substrate 12 and corresponding to the data lines D. The black matrix BM is made by opaque material, such as metal (e.g. Cr, chromium oxide, or Cr—O—N compound) or resin. In this embodiment, the black matrix BM is disposed on the side of the second substrate 12 facing the first substrate 11 and over the data line D along the third direction Z. Accordingly, the black matrix BM can cover the data lines D in a top view of the display panel 1. The color filter layer is disposed on the side of the second substrate 12 and black matrix BM facing the first substrate 11 or disposed on the first substrate 11. Since the black matrix BM is opaque, a corresponding opaque area can be formed on the second substrate 12 and a transparent area can be thus defined. The black matrix BM includes a plurality of light-blocking segments, and at least one light-blocking segment is disposed between two adjacent color filter portions of the color filter layer. In this embodiment, the black matrix BM and the color filter layer are both disposed on the second substrate 12. In other embodiments, however, the black matrix BM or the color filter layer can be disposed on the first substrate 11 for making a BOA (BM on array) substrate or a COA (color filter on array) substrate. To be noted, the above-mentioned structure of the substrate is just for illustration but not for limiting the scope of the invention. Moreover, the display panel 1 can further include a protection layer (e.g. an over-coating, not shown), which can cover the black matrix BM and the color filter layer. The protection layer can include photoresist material, resin material or inorganic material (e.g. SiOx/SiOx), protecting the black matrix BM and the color filter layer from being damaged by the subsequent processes.

Accordingly, when the scan lines G of the display panel 1 receive the scan signals and the corresponding thin film transistors are thus turned on, the corresponding data signals can be transmitted to the corresponding pixel electrodes through the data lines D and the display panel 1 can thus display images. In this embodiment, the gray-level voltages can be transmitted to the second electrode layers 143 (pixel electrodes) of the pixels P through the data lines D, so that an electric field is formed between the first and second electrode layers 141 and 143 to drive the liquid crystal molecules of the liquid crystal layer 13 to rotate on the plane of the first and second directions X and Y, and therefore the light can be modulated and the display panel 1 can display images accordingly.

The second electrode layer 143 includes a plurality of electrode portions 1431 and a first connecting portion 1432. In this embodiment, as shown in FIG. 1D, the second electrode layer 143 includes three electrode portions 1431 (the quantity of the electrode portions 1431 may be changed, e.g. 2, 4, . . . ), and the first connecting portion 1432 is disposed on the opposite two sides of the electrode portions 1431 and connected with the electrode portions 1431. The electrode portions 1431 are disposed parallelly along the first direction X and separated from each other by a first distance S (or the first distance S is the shortest distance between the two adjacent electrode portions 1431), and each of the electrode portions 1431 of the second electrode layer 143 has an electrode width W along the first direction X. The electrode width W may have a range such as 0.5 μm≦W≦10 μm or 1 μm≦W≦5 μm favorably.

Due to the electrode pattern of the second electrode layer 143, when the second electrode layer 143 (pixel electrode) is driven by a voltage and a light passes through the electrode portions 1431, a brightness distribution composed of a plurality bright textures and a plurality of dark textures occurring along the first direction X will be generated. In other words, when the light passes through the electrode portions 1431, the bright textures and the dark textures are generated. Besides, the dark textures correspond to the wave valleys of the brightness distribution curve C and the bright textures correspond to the wave peaks of the brightness distribution curve C. As shown in FIG. 1C, the dark textures include a first dark texture (denoted by 1), a second dark texture (denoted by 2) and a third dark texture (denoted by 3) which occur consecutively. Besides, the centers of the first dark texture and third dark texture are separated from each other by a second distance K. The center of the first dark texture or the center of the third dark texture can correspond to between the two adjacent electrode portions 1431, and the center of the second dark texture can correspond to one of the electrode portions 1431. In this embodiment, the centers of the first and third dark texture correspond to the middles between the two adjacent electrode portions 1431, respectively, and the center of the second dark texture corresponds to one of the electrode portions 1431. However, in other embodiments, the second distance K can be the distance between the center of the first electrode portion 1431 and the center of the third electrode portion 1431 along the first direction X. Moreover, in other embodiments, the center of the first dark texture or the center of the third dark texture also can correspond to one of the electrode portions 1431, and the center of the second dark texture can correspond to between the two adjacent electrode portions 1431. The above is not meant to be construed in a limiting sense, as long as the wave valley (or wave peak) of the brightness distribution curve C or the center of the dark texture corresponds to between the edges of the electrode portions 1431 farthest distant from each other. Otherwise, in another embodiment, the bright textures also can include the first bright texture, the second bright texture and the third bright texture which occur consecutively, and the second distance K also can be defined as the distance between the centers of the first bright texture and third bright texture.

To be noted, this embodiment is given by that, for example, the dark textures include the first, second and third dark textures occurring consecutively and the centers of the first and third dark textures are separated from each other by the second distance K. However, since the dark texture corresponds to the wave valley of the brightness distribution curve C and the bright texture corresponds to the wave peak of the brightness distribution curve C, the wave valleys, as shown in FIG. 1B, can include the first, second and third wave valleys occurring consecutively and the second distance K also can be defined as the distance between the first wave valley and the third wave valley. Herein, the first or third wave valley can correspond to between the two adjacent electrode portions 1431 and the second wave valley corresponds to one of the electrode portions 1431. Or, the first or third wave valley can correspond to one of the electrode portions 1431 and the second wave valley corresponds to between the two adjacent electrode portions 1431. Otherwise, in another embodiment, the wave peaks also can include the first, second and third wave peaks occurring consecutively and the second distance K also can be defined as the distance between the first wave peak and the third wave peak.

From the brightness distribution curve C in FIG. 1B, it can be found that the transmittance of the pixel P can be derived from the integral of the brightness distribution curve C. In other words, the transmittance is equivalent to the area under the curve C obtained by the integral of the brightness distribution curve C. However, the transmittance of the display panel 1 will be affected by the bright and dark texture distribution. In order to analyze the transmittance of the display panel 1, the transmittance of the pixel P can be analyzed first. If the pixel P has the optimum transmittance, then the entire transmittance of the display panel 1 can be derived as the best.

From the brightness distribution curve, it can be found that the when the second distance K becomes greater, the wave valley (dark texture) will descend and the brightness (integral area) will thus become less. Moreover, when the second distance K becomes greater, the wave peak (bright texture) will ascend and the brightness (integral area) will thus become greater. Therefore, at a certain distance (i.e. the first distance S) of the electrodes 1431, as long as the optimum second distance K can be correspondingly found, the whole brightness integral (i.e. the brightness integral of the dark texture period K or the brightness integral of the bright texture period K) can be made the maximum, and thus the transmittances of the pixel P and display panel 1 will be optimum.

Accordingly, the first distance S and the second distance K are the factors affecting the brightness distribution curve C and also the transmittance, so the function L(x) containing the parameters K and S is used to describe the relation thereof in this embodiment. The function L(x) is a brightness distribution curve equation (x is a position variable):

L(x)=a·cos (bx)+c·sin (dx)+e

wherein

a=0.04482K−0.0767

b=12.55K⁻¹=2d

c=c₁·K³+c₂·K²+c₃·K+c₄

c₁=−0.17599S³+1.77854S²−5.97827S+6.57827

c₂=2.56533S³−25.736S²+86.37067S−95.132

c₃=−12.46535S³+123.46346S²−412.31639S+453.83373

i c₄=20.47333S³−198.62S²+656.08467S−718.876

e=e₁·K²+e₂·K+e₃

e₁=−0.021S²+0.1295S−0.23025

e₂=0.2441S²+1.44523S+2.44268

e₃=−0.76545S²+4.425S−6.38595

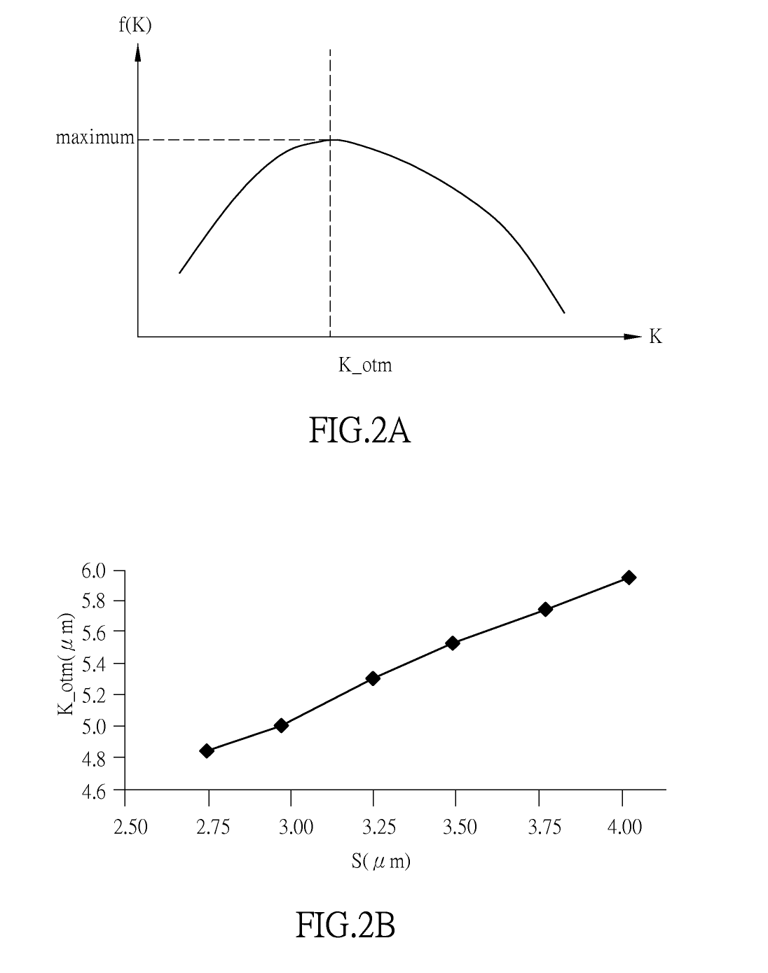

Then, a length integral of a bright texture (or dark texture) period K is done by using the above function L(x) and then multiplied by 1/K, and therefore the brightness distribution integral function f(K) of a unit bright texture (or dark texture) period K can be obtained, i.e. the relational function between the unit brightness (Lu) and the bright texture (or dark texture) period K: Lu=f(K). As shown in FIG. 2A, the f(K) is differentiated and then made equal to zero to obtain the extreme value, as follows:

$$\frac{d}{d K} [ \frac{{\int }_{0}^{K} L ( x ) d x}{K} ] = 0$$

$$wherein$$

$$L ( x ) = a \cdot cos ( bx ) + c \cdot sin ( dx ) + e$$

Besides, a, b, c, d, e are the coefficients containing K and S. Therefore, the relational equation of K=h(S) between the optimum value (i.e. K_otm) of the bright texture (or dark texture) period and the first distance S under the optimum transmittance can be obtained.

Since the equation of K=h(S) is really complicated, it is not directly solved in this invention but solved with a numerical solution. In the numerical solution, a certain value S is applied to the above function L(x), and a length integral of a bright texture (or dark texture) period K by using the function L(x) is performed and then multiplied by 1/K (because of the integral of the length K, the result needs to be multiplied by 1/K to obtain the brightness distribution integral under the unit bright texture period) and normalized. Thereby, the relational function Lu=f(K) of the unit brightness Lu and the bright texture period K under the value S can be derived as follows:

$$Lu = \frac{{\int }_{0}^{K} L ( x ) d x}{K}$$

$$wherein$$

$$L ( x ) = a \cdot cos ( bx ) + c \cdot cos ( dx ) + e$$

Since S has been applied with a value, the coefficients a, b, c, d, e only contain K. Then, find the optimum value (K_otm) corresponding to the maximum value of f(K) under the value S. Accordingly, the above computation is repeated by different values S so that the corresponding optimum values (K_otm) can be obtained with the different values S. Hence, by using different values S to obtain the corresponding optimum values (K_otm), the relational equation K=h(S), under the optimum transmittance, between the first distance S and the optimum values (K_otm) of the bright texture (or dark texture) can be obtained. For example, when S=3 μm, f(K)=−0.13313K²+1.33461K−0.30853, and when the differential of f(K) is derived and made equal to zero to obtain the extreme value, the optimum value of K can be derived as 5.01243 μm; when S=3.5 μm, f(K)=−0.15858K²+1.75793K−1.82412, and when the differential of f(K) is derived and made equal to zero to obtain the extreme value, the optimum value of K can be derived as 5.54272 μm; etc. Therefore, as shown in FIG. 2B, the equation K=h(S) (equation 1) can be obtained as follows:

K=−0.43715×S³+4.37035×S²−13.49956×S+17.98982 (equation 1)

wherein 1≦S≦10, and S and K in unit of μm.

In other words, when the relation between K and S satisfy the equation (1), the pixel P can have a better transmittance and the display panel 1 can thus have a better transmittance. However, in consideration of the process variation, the display panel 1 can have a better transmittance in this embodiment when K and S satisfy the following inequality:

(−0.43715×S³+4.37035×S²−13.49956×S+17.98982)−0.5≦K≦(−0.43715×S³+4.37035×S²−13.49956×S+17.98982)+0.5

Favorably, the display panel 1 can have a much better transmittance when K and S satisfy the following inequality:

(−0.43715×S³+4.37035×S²−13.49956×S+17.98982)−0.3≦K≦(−0.43715×S³+4.37035×S²−13.49956×S+17.98982)+0.3

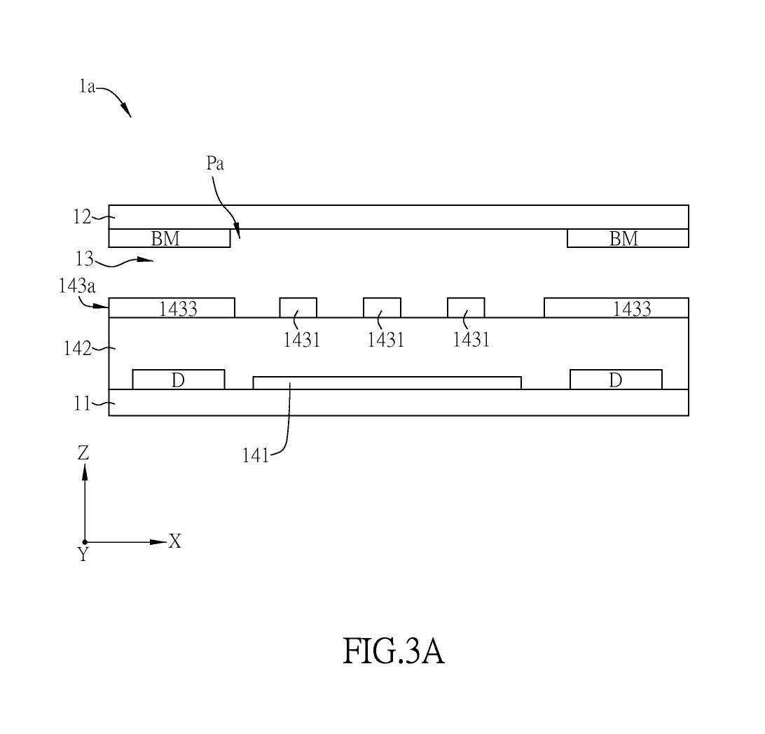

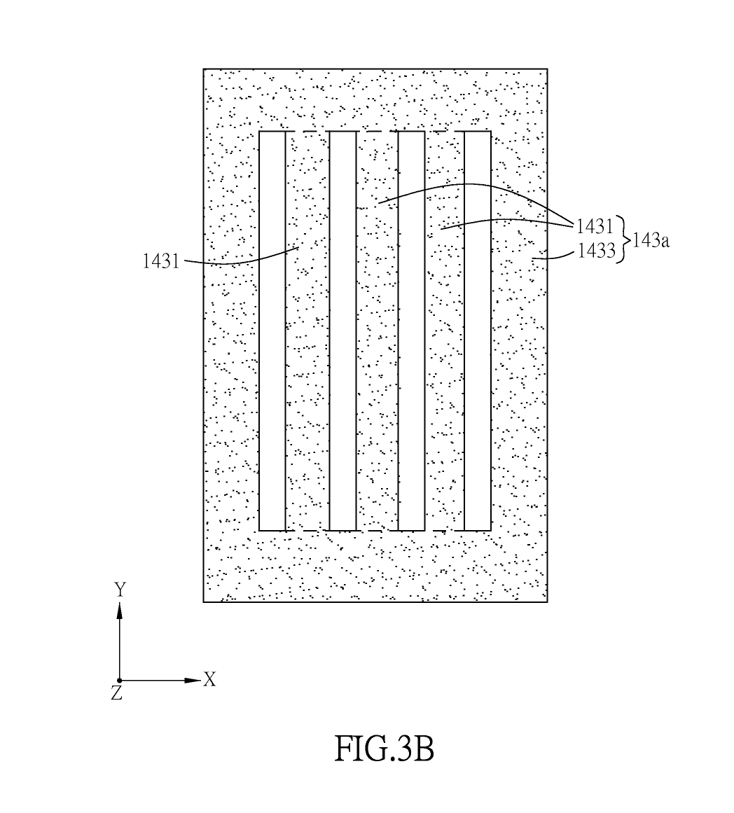

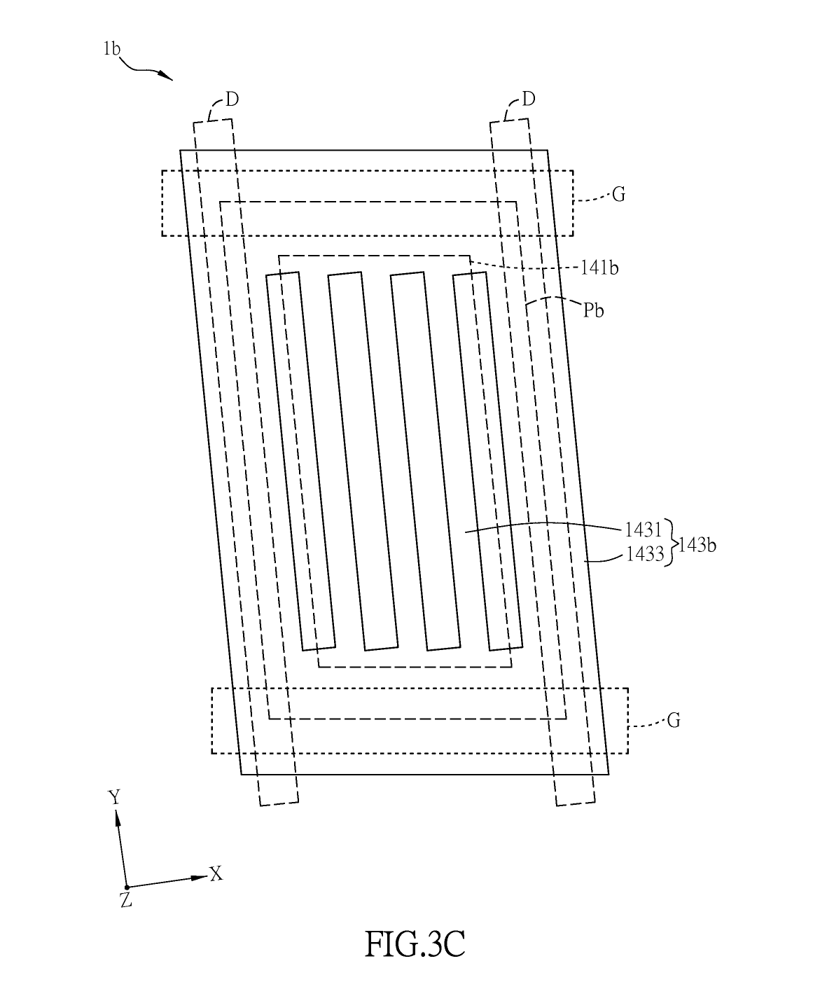

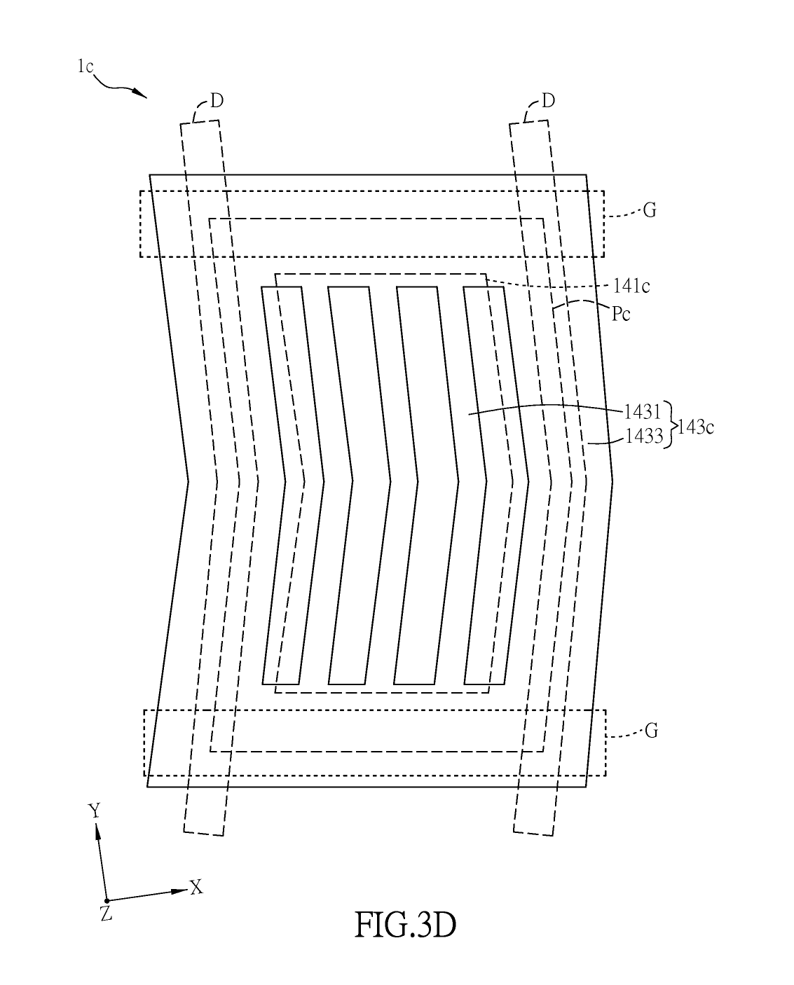

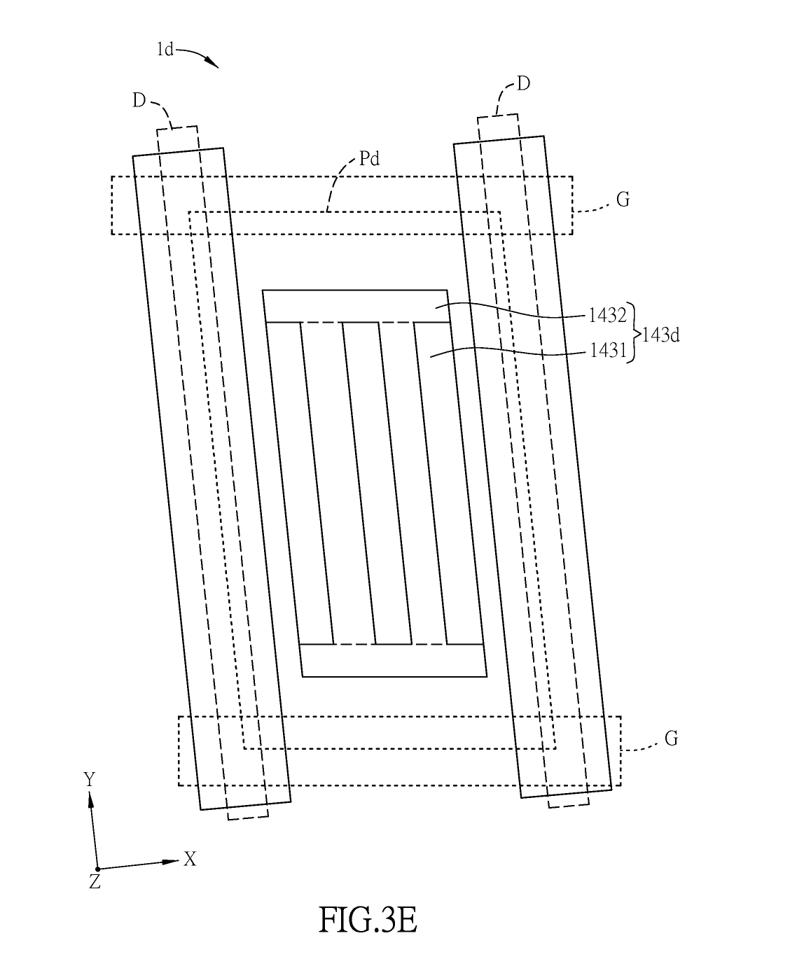

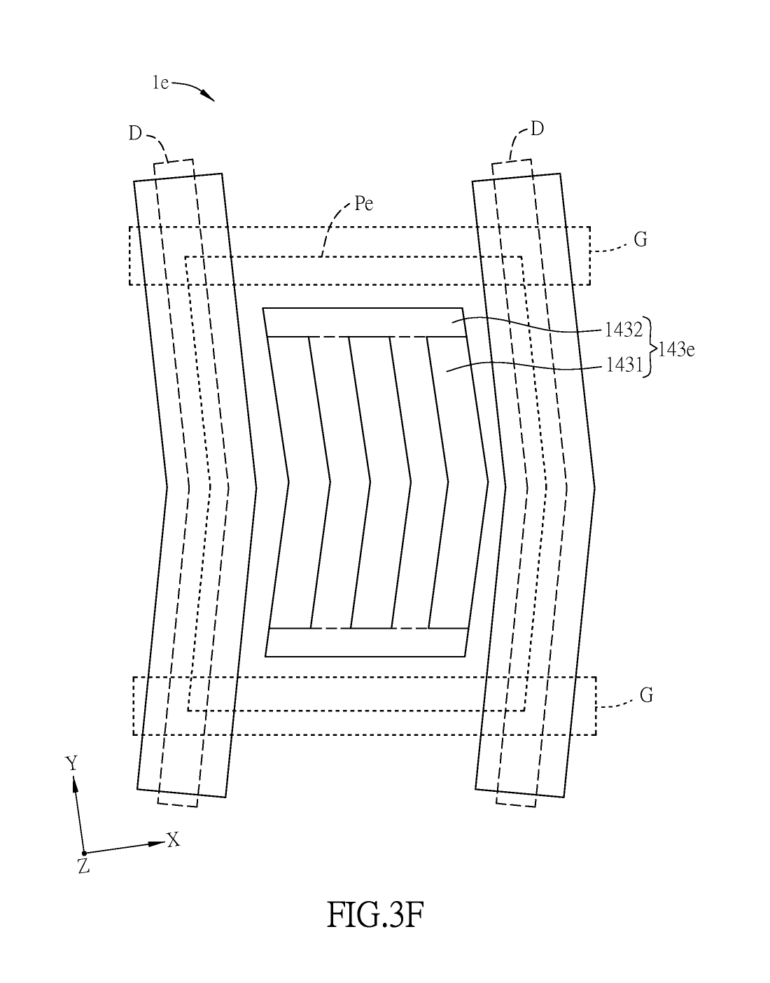

FIG. 3A is a schematic sectional diagram of a display panel 1a of another embodiment of the invention, FIG. 3B is a schematic diagram of the second electrode layer 143a of the display panel la in FIG. 3A, and FIGS. 3C to 3F are schematic diagrams of the pixels Pb, Pc, Pd, Pe of the display panels 1b, 1c, 1d, 1e, respectively, of other embodiments of the invention.

As shown in FIG. 3A, the main difference between the display panel la and the display panel 1 in FIG. 1B is that the first electrode layer 141 of the pixel Pa of the display panel 1a is pixel electrode and the second electrode layer 143a is common electrode. The data line D and the first electrode layer 141 are disposed on the first substrate 11. Herein, the first electrode layer 141 is disposed within the two adjacent data lines D and two adjacent scan lines G, and the second electrode layer 143a is insulated from the first electrode layer 141 and the data line D by the insulating layer 142. As shown in FIG. 3B, the second electrode layer 143a includes three electrode portions 1431 and a second connecting portion 1433, and the second connecting portion 1433 is disposed around and connected with the electrode portions 1431.

Other technical features of the display panel 1a can be comprehended by referring to the above display panel 1 and therefore the related descriptions are omitted here for conciseness.

As shown in FIG. 3C, the main difference between the display panel 1b and the display panel 1a is that the second direction Y, in the display panel 1b, is still substantially parallel to the extension direction of the data line D and the first direction X is still substantially perpendicular to the electrode portions 1431, so that the first direction X and the second direction Y are perpendicular to each other and the pixel Pb is shaped like a parallelogram. In other words, the scan lines G and the data lines D of the display panel lb still cross each other, but they are not perpendicular to each other and have an obtuse angle therebetween, such that the first electrode layer 141b and the second electrode layer 143b are both shaped like a parallelogram substantially.

Other technical features of the display panel 1b can be comprehended by referring to the above display panel 1a and therefore the related descriptions are omitted here for conciseness.

As shown in FIG. 3D, the main difference between the display panel 1c and the display panel 1b is that the data line D, in the pixel Pc of the display panel 1c, has a bent portion, so that the pixel Pc is not a parallelogram but has a bent portion corresponding to the bent portion of the data line D. Besides, the electrode portion 1431 and the second connecting portion 1433 of the second electrode layer 143c both have a bent portion corresponding to the data line D, and the first electrode portion 141c also has a bent portion corresponding to the data line D. Moreover, the first direction X is still substantially perpendicular to the upper portion of the electrode portion 1431 of the second electrode layer 143c and the second direction Y is still substantially parallel to the upper portion of the data line D, so that the first direction X and the second direction Y are still perpendicular to each other.

Other technical features of the display panel 1c can be comprehended by referring to the above display panel 1b and therefore the related descriptions are omitted here for conciseness.

As shown in FIG. 3E, the main difference between the display panel 1d and the display panel 1b is that the second electrode layer 143d, in the pixel Pd of the display panel 1d, is pixel electrode and electrically connected with the data line D while the first electrode layer (not shown) is common electrode. The second electrode layer 143d includes three electrode portions 1431 and a first connecting portion 1432, and the first connecting portion 1432 is disposed on the opposite two sides of the electrode portions 1431 and connected with the electrode portions 1431.

Other technical features of the display panel 1d can be comprehended by referring to the above display panel 1b and therefore the related descriptions are omitted here for conciseness.

As shown in FIG. 3F, the main difference between the display panel 1e and the display panel 1c is that the second electrode layer 143e, in the pixel Pe of the display panel 1e, is pixel electrode and electrically connected with the data line D while the first electrode layer (not shown) is common electrode. The second electrode layer 143e includes three electrode portions 1431 and a first connecting portion 1432, and the first connecting portion 1432 is disposed on the opposite two sides of the electrode portions 1431 and connected with the electrode portions 1431.

Other technical features of the display panel 1e can be comprehended by referring to the above display panel 1c and therefore the related descriptions are omitted here for conciseness.

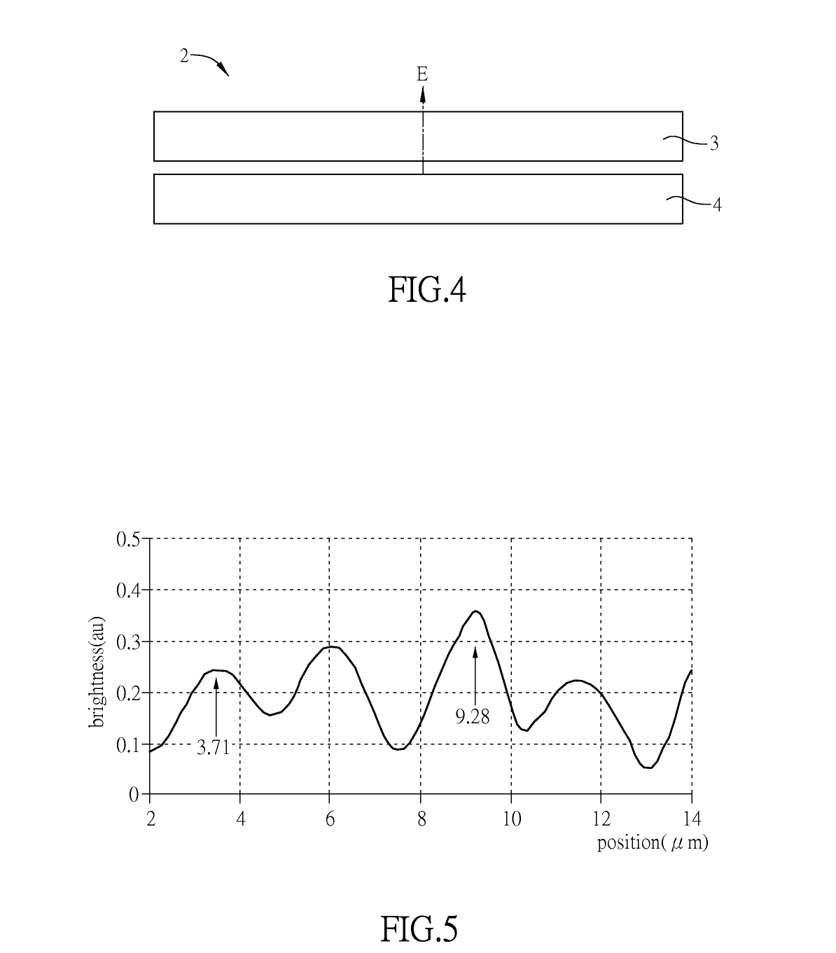

FIG. 4 is a schematic diagram of a display device 2 of an embodiment of the invention.

As shown in FIG. 4, the display device 2 includes a display panel 3 and a backlight module 4, and the display panel 3 and the backlight module 4 are disposed oppositely. The display panel 3 can have the features of at least one of the above display panels 1, 1a, 1b, 1c, 1d, 1e and their variations, so the related description is omitted here for conciseness. When the backlight module 4 emits the light E passing through the display panel 3, the pixels of the display panel 3 can display colors to form images.

To be noted, in order to obtain the brightness distribution curve C of the pixel P, the optical microscopy (OM), for example, can be used to shoot the bright and dark textures generated when the light passes through the second electrode layer 143 (at this time, the display panel is on the full-bright gray level state). The magnification of the optical microscopy is 20× for example, and the definition of the picture is 640×480 for example. During the image shooting, the gray level of each position along the direction which the electrode portions 1431 are substantially parallelly disposed according to (i.e. the first direction X) is converted into data and therefore the raw data of the brightness distribution along the direction can be obtained.

However, due to the shooting problem of the optical microscopy (e.g. the definition problem), the bright and dark textures may be not very clear and the raw data of the brightness distribution will contain much noise. Therefore, the raw data need to be processed by the smoothing implemented by a software (e.g. OriginPro7.5) to obtain the smoothed brightness distribution curve, as shown in FIG. 5.

Summarily, in the display panel of the invention, the electrode portions of the electrode layer are disposed along a direction and separated from each other by a first distance (S). When a light passes through the electrode portions, a brightness distribution composed of a plurality of bright textures and a plurality of dark textures is generated. The dark textures include a first dark texture, a second dark texture and a third dark texture occurring consecutively, and the centers of the first dark texture and third dark texture are separated by a second distance (K). Or, when a light passes through the electrode portions, a brightness distribution is generated and has a brightness distribution curve along the direction, and the brightness distribution curve is composed of a plurality of wave peaks and a plurality of wave valleys. The wave valleys include a first wave valley, a second wave valley and a third wave valley occurring consecutively, and the first wave valley and the third wave valley are separated by a second distance (K). The display panel can have a better transmittance when K and S satisfy the following equation:

(−0.43715×S³+4.37035×S²−13.49956×S+17.98982)−0.5≦K≦(−0.43715×S³+4.37035×S²−13.49956×S+17.98982)+0.5,1≦S≦10,

and S and K in unit of micrometer.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display panel, comprising:
a first substrate and a second substrate disposed opposite the first substrate; and
an electrode layer disposed on the first substrate and facing the second substrate, and including a plurality of electrode portions which are disposed along a direction and separated from each other by a first distance (S), wherein when a light passes through the electrode portions, a brightness distribution composed of a plurality of bright textures and a plurality of dark textures is generated, the dark textures include a first dark texture, a second dark texture and a third dark texture occurring consecutively, the centers of the first dark texture and third dark texture are separated by a second distance (K), and K and S satisfy the following equation:
(−0.43715×S³+4.37035×S²−13.49956×S+17.98982)−0.5≦K≦(−0.43715×S³+4.37035×S²−13.49956×S+17.98982)+0.5, 1≦S≦10,
and S and K in unit of micrometer.

2. The display panel as recited in claim 1, wherein K and S further satisfy the following equation:
(−0.43715×S³+4.37035×S²−13.49956×S+17.98982)−0.3≦K≦(−0.43715×S³+4.37035×S²−13.49956×S+17.98982)+0.3

3. The display panel as recited in claim 1, wherein the electrode layer further includes a first connecting portion, which is disposed on the opposite two sides of the electrode portions and connected with the electrode portions.

4. The display panel as recited in claim 1, wherein the electrode layer further includes a second connecting portion, which is disposed around the electrode portions and connected with the electrode portions.

5. The display panel as recited in claim 1, wherein the center of the first dark texture or the center of the third texture corresponds to between the two adjacent electrode portions and the center of the second dark texture corresponds to one of the electrode portions.

6. The display panel as recited in claim 1, wherein the center of the first dark texture or the center of the third texture corresponds to one of the electrode portions and the center of the second dark texture corresponds to between the two adjacent electrode portions.

7. A display panel, comprising:
a first substrate and a second substrate disposed opposite the first substrate; and
an electrode layer disposed on the first substrate and facing the second substrate, and including a plurality of electrode portions which are disposed along a direction and separated from each other by a first distance (S), wherein when a light passes through the electrode portions, a brightness distribution is generated and has a brightness distribution curve along the direction, and the brightness distribution curve is composed of a plurality of wave peaks and a plurality of wave valleys, the wave valleys include a first wave valley, a second wave valley and a third wave valley occurring consecutively, and the first wave valley and the third wave valley are separated by a second distance (K), and K and S satisfy the following equation:
(−0.43715×S³+4.37035×S²−13.49956×S+17.98982)−0.5≦K≦(−0.43715×S³+4.37035×S²−13.49956×S+17.98982)+0.5, 1≦S≦10,
and S and K in unit of micrometer.

8. The display panel as recited in claim 1, wherein K and S further satisfy the following equation:
(−0.43715×S³+4.37035×S²−13.49956×S+17.98982)−0.3≦K≦(−0.43715×S³+4.37035×S²−13.49956×S+17.98982)+0.3

9. The display panel as recited in claim 7, wherein the electrode layer further includes a first connecting portion, which is disposed on the opposite two sides of the electrode portions and connected with the electrode portions.

10. The display panel as recited in claim 7, wherein the electrode layer further includes a second connecting portion, which is disposed around the electrode portions and connected with the electrode portions.

11. The display panel as recited in claim 7, wherein the first wave valley or the third wave valley corresponds to between the two adjacent electrode portions and the second wave valley corresponds to one of the electrode portions.

12. The display panel as recited in claim 7, wherein the first wave valley or the third wave valley corresponds to one of the electrode portions and the second wave valley corresponds to between the two adjacent electrode portions.
